(19) United States
(12) Patent Application Publication
(10) Pub. No.: US 2010/0198648 A1
(43) Pub. Date: Aug. 5, 2010

(54) DYNAMIC MEETING GROUP ORGANIZER

(75) Inventors: Judith Helen Bank, Morrisville, NC (US); Regina Ann Moliff, Spicewood, TX (US); Christine Posluszny, Austin, TX (US)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/366,322

(22) Filed: Feb. 5, 2009

(51) Int. Cl. G06Q 10/00; G06F 15/16

(52) U.S. Cl. 705/9; 705/10; 709/204

(57) ABSTRACT

A Dynamic Meeting Group Organizer automatically creates sub-groups from a group of responders to a meeting invitation sent by email by determining a number of subgroups and a subgroup size parameter; determining a question and a criteria associated with the question to create a survey; determining a list of invitees and a response date by which an invitee is to return a completed survey; sending a plurality of invitations with the survey attached to each invitee on the list; accumulating a plurality of responses to the questionnaire in a response file; and accessing the response file and automatically processing the plurality of responses by organizing the list of invitees into a plurality of subgroups according to each invitee's response to the question and the subgroup size parameter.

### BACKGROUND OF THE INVENTION

1. Field of the Invention

The invention relates generally to scheduling meetings in a data processing system and more specifically to automatically creating subgroups for a scheduled meeting based on responses to an invitation.

2. Description of the Related Art

Organizations with large numbers of potential participants often hold events or meetings that involve most or all of the potential participants. The potential participants may be invited to attend in conference rooms or lecture halls where a screen can present the speaker to everyone at the same time. Additionally, the potential participants can be linked in a telephone conference or by computer video conferencing. Technology exists to link thousands of participants together for a single event or conference.

However, although the technology exists to link thousands of participants together for a single event or conference, notification and scheduling of such events increases in complexity when the participants are in different locations. The different locations may be in different cities within a single state or in multiples states. With increasing frequency, locations are in different countries as well. The variations in geographic location may span many time zones in the continental United States or across the world. When potential participants are dispersed in space and in time, inviting all potential participants to an event or meeting is often impractical. Restrictions on scheduling of such an event or a meeting include space in meeting rooms, the number of conference call lines available, schedule conflicts, and time zone differences.

Therefore, managers often have to divide up a large group of invitees into smaller groups. Moreover, managers then have to communicate with each of the groups and deal with problems such as creating a team calendar, finding free time for some but not all meeting invitees, using a geophysical position system (GPS) to find a meeting location for a group of invitees, inviting parties to join a chat room, and electronic calendaring. But when an organization sends out an organization-wide meeting invitation that initially solicits responses as to who will attend, those invitees who respond need to be formed into groups. Moreover, those who respond need to be subsequently sent follow up questions or instructions specific to each group to which they have been assigned. Presently, the meeting originator must manually review a list of those invitees who responded positively and then divide that list of invitees into multiple groups based on a criteria. Invitees are then sent a list of members who belong to the same group.

Each of the multiple groups needs a customized email distribution list when new material specific to that subgroup is subsequently developed and sent. Failure to create subsets of the distribution list causes confusion because all groups would then receive all follow up material. Moreover, individuals need to sort out which specific documents pertain to their group. When invitees responding to the customized documentation using “reply to all,” the invitees responses are sent to the entire organization. Since the responses are to documents related to their group, recipients who are not members of their group are confused by the email.

What is needed is a way to dynamically and automatically divide a large group of invitees into multiple smaller groups, each having a discrete email distribution list.

### BRIEF SUMMARY OF THE INVENTION

A Dynamic Meeting Group Organizer automatically creates sub-groups from a group of responders to a meeting invitation sent by email. Using a computer and a graphical user interface displayed by the computer, and responsive to a plurality of first inputs to a first screen of the graphical user interface, the Dynamic Meeting Group Organizer performs steps comprising: determining a number of subgroups and a subgroup size parameter; responsive to a plurality of second inputs to a second screen of the graphical user interface, determining a question and a criteria associated with the question to create a survey; responsive to a plurality of third inputs, determining a list of invitees and a response date by which an invitee is to return a completed survey; sending a plurality of invitations with the survey attached to each invitee on the list; accumulating a plurality of responses to the questionnaire in a response file; and accessing the response file and automatically processing the plurality of responses by organizing the list of invitees into a plurality of subgroups according to each invitee's response to the question, and according to the subgroup size parameter.

### BRIEF DESCRIPTION OF THE SEVERAL VIEWS OF THE DRAWINGS

FIG. 1 depicts an exemplary server-client computer system;

FIG. 2 depicts an exemplary computer framework;

FIG. 3 depicts an exemplary software architecture for a server-client system containing application software;

FIG. 4 depicts a memory containing elements of the application software;

FIG. 5A depicts a chart of the components of Dynamic Meeting Group Organizer Program;

FIG. 5B depicts an initial screen of Dynamic Meeting Group Organizer graphical user interface;

FIG. 5C depicts a configuration screen of the Dynamic Meeting Group Organizer graphical user interface;

FIG. 5D depicts a survey creation screen of the Dynamic Meeting Group Organizer graphical user interface;

FIG. 5E depicts a new criteria screen of the Dynamic Meeting Group Organizer graphical user interface;

FIG. 5F depicts a new question screen of the Dynamic Meeting Group Organizer graphical user interface;

FIG. 6 depicts a flow chart of the configuration component of the Dynamic Meeting Group Organizer;

FIG. 7 depicts a flow chart of the survey generation component of the Dynamic Meeting Group Organizer;

FIG. 8 depicts a flow chart of the initial invitation component of the Dynamic Meeting Group Organizer;

FIG. 9 depicts a flow chart of the group generation component of the Dynamic Meeting Group Organizer; and

FIG. 10 depicts a flow chart of the invitee component of the Dynamic Meeting Group Organizer.

### DETAILED DESCRIPTION OF THE INVENTION

As will be appreciated by one skilled in the art, the Dynamic Meeting Group Organizer may be embodied as a system, method or computer program product. Accordingly, the Dynamic Meeting Group Organizer may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the Dynamic Meeting Group Organizer may take the form of a computer program product embodied in any tangible medium of expression having computer usable program code embodied in the medium.

Any combination of one or more computer-usable or computer-readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to, wireless, wireline, optical fiber cable, and RF.

Computer program code for carrying out operations of the Dynamic Meeting Group Organizer may be written in any combination of one or more programming languages, including an object oriented programming language such as Java, Smalltalk, C++ or the like and conventional procedural programming languages, such as the “C” programming language or similar programming languages. The computer program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The Dynamic Meeting Group Organizer is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable data processing apparatus to produce a computer implemented process such that the instructions which execute on the computer or other programmable data processing apparatus provide processes for implementing the functions/acts specified in the flowchart and/or block diagram block or blocks.

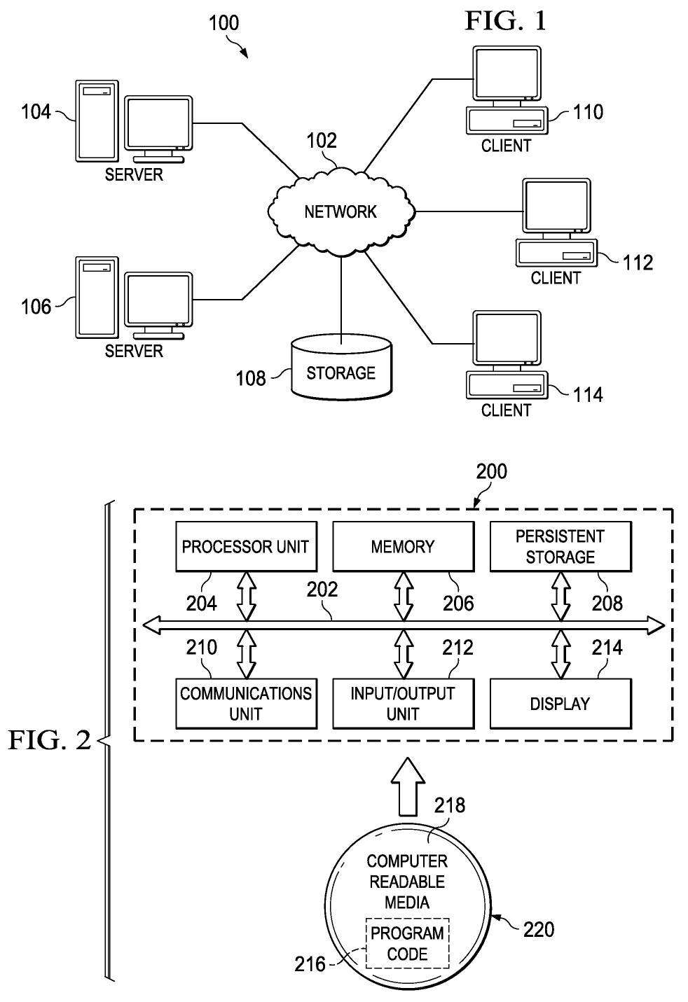

With reference now to the figures, and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communication links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer-usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer-usable program code, or computer-readable program code that may be read and executed by a processor in processor unit 204. The program code in the different embodiments may be embodied on different physical or tangible computer-readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer-readable media 218 form computer program product 220 in these examples. In one example, computer-readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer-readable media 218 also may take the form of a persistent storage, such as a hard drive, a thumb drive, or a flash memory that is connected to data processing system 200. The tangible form of computer-readable media 218 is also referred to as computer-recordable storage media. In some instances, computer-recordable media 218 may not be removable.

Alternatively, program code 216 may be transferred to data processing system 200 from computer-readable media 218 through a communications link to communications unit 210 and/or through a connection to input/output unit 212. The communications link and/or the connection may be physical or wireless in the illustrative examples. The computer-readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown.

The different embodiments may be implemented using any hardware device or system capable of executing program code. As one example, the data processing system may include inorganic components integrated with organic components and/or may be comprised entirely of organic components excluding a human being. For example, a storage device may be comprised of an organic semiconductor. As another example, a storage device in data processing system 200 is any hardware apparatus that may store data. Memory 206, persistent storage 208, and computer-readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

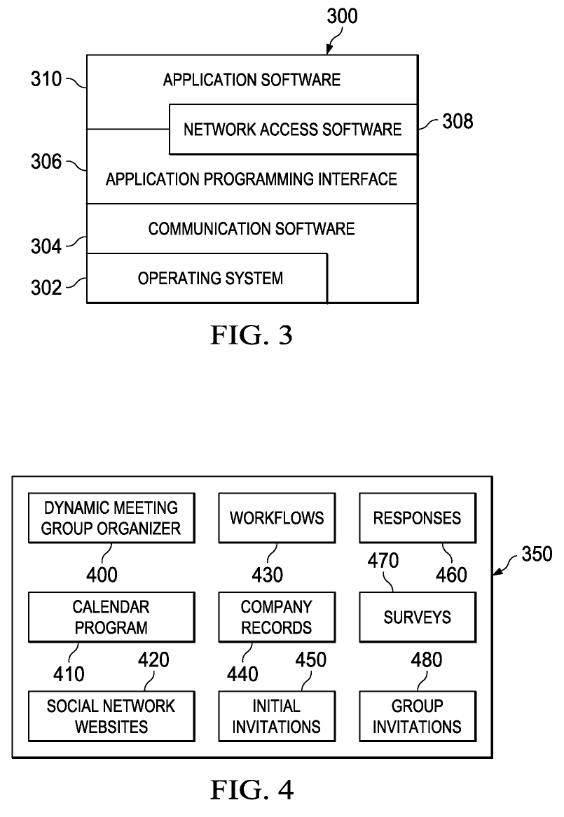

Turning to FIG. 3, typical software architecture for a server-client system is depicted in accordance with an illustrative embodiment. At the lowest level, operating system 302 is utilized to provide high-level functionality to the user and to other software. Such an operating system typically includes a basic input/output system (BIOS). Communication software 304 provides communications through an external port to a network, such as the Internet, via a physical communications link by either directly invoking operating system functionality or indirectly bypassing the operating system to access the hardware for communications over the network.

Application programming interface (API) 306 allows the user of the system, such as an individual or a software routine, to invoke system capabilities using a standard consistent interface without concern for how the particular functionality is implemented. Network access software 308 represents any software available for allowing the system to access a network. This access may be to a network, such as a local area network (LAN), wide area network (WAN), or the Internet. With the Internet, this software may include programs, such as Web browsers. Application software 310 represents any number of software applications designed to react to data through the communications port to provide the desired functionality the user seeks. Applications at this level may include those necessary to handle data, video, graphics, photos or text, which can be accessed by users of the Internet. The mechanism of Dynamic Meeting Group Organizer 400 may be implemented within communications software 304 in these examples.

FIG. 4 depicts an exemplary memory or storage 350 containing elements of Dynamic Meeting Group Organizer 400 and files accessed by Dynamic Meeting Group Organizer 400. Specifically, exemplary memory or storage 350 contains Dynamic Meeting Group Organizer 400, calendar program 410, initial invitations file 450, responses file 460, and group invitations file 480. In addition, Dynamic Meeting Group Organizer 400 may interact with social networking website file 420 and workflow file 430.

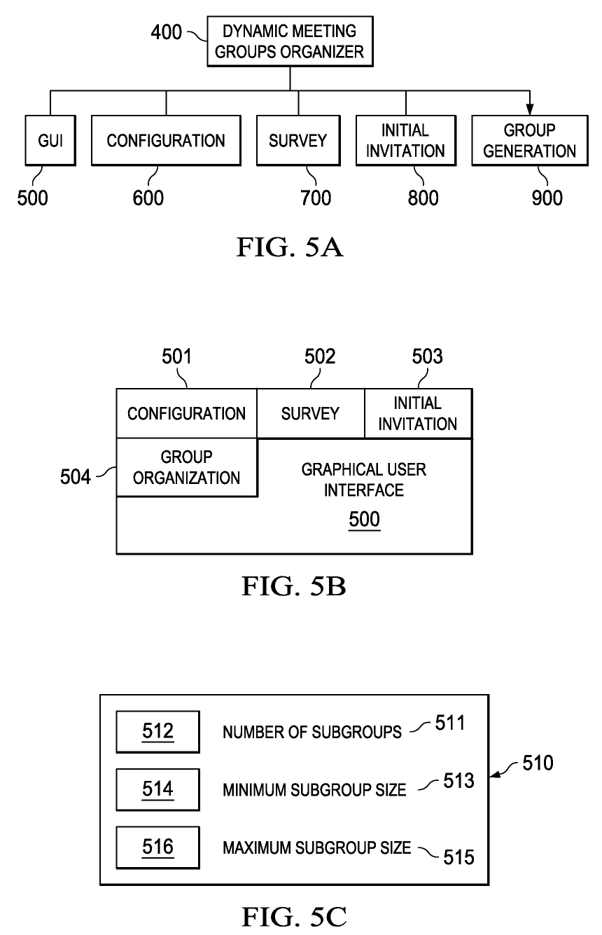

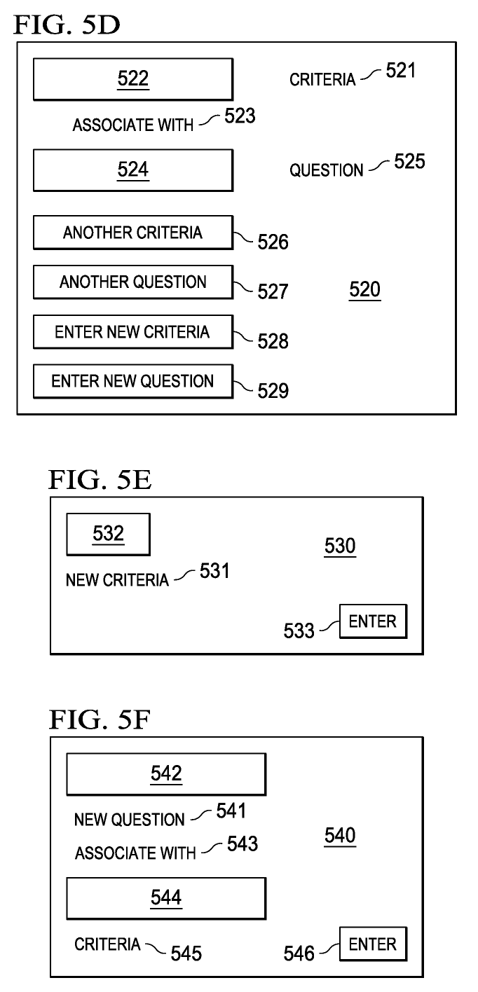

FIG. 5A depicts Dynamic Meeting Group Organizer 400 having configuration component 600, survey component 700, initial invitation component 800, and group generation component 900. Each of these components will be discussed in detail below. First, however, the graphical user interface of Dynamic Meeting Group Organizer 400 will be discussed.

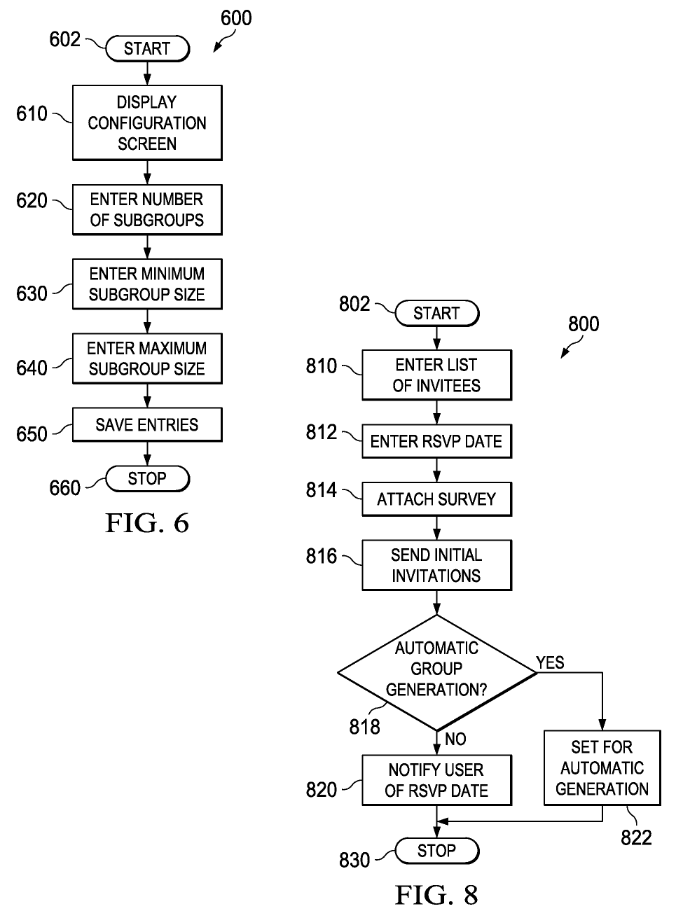

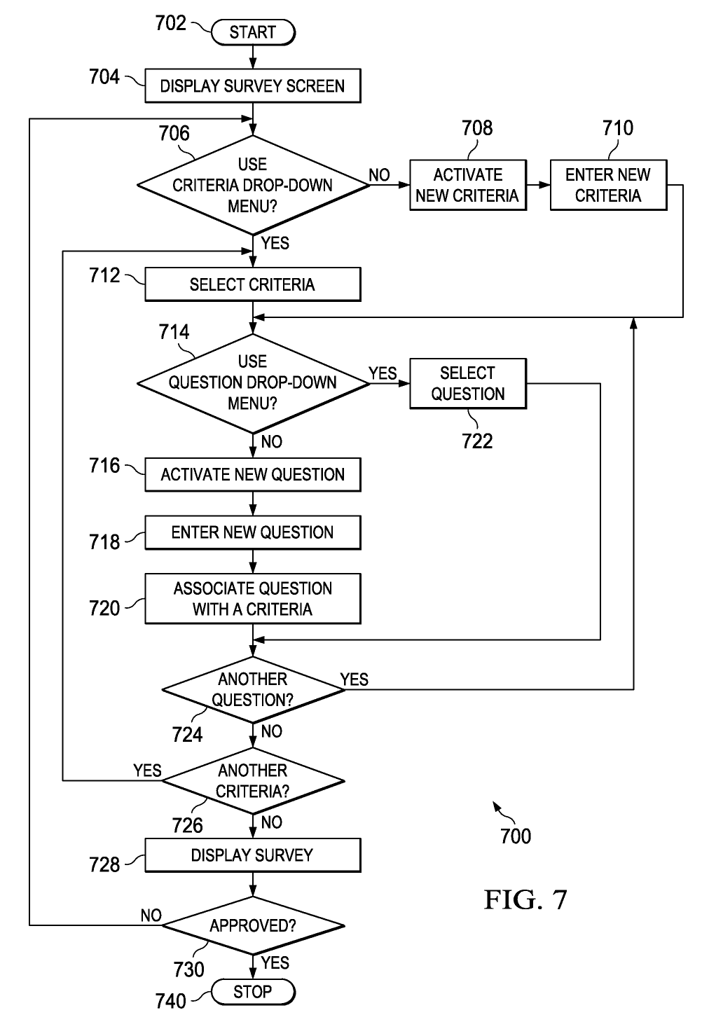

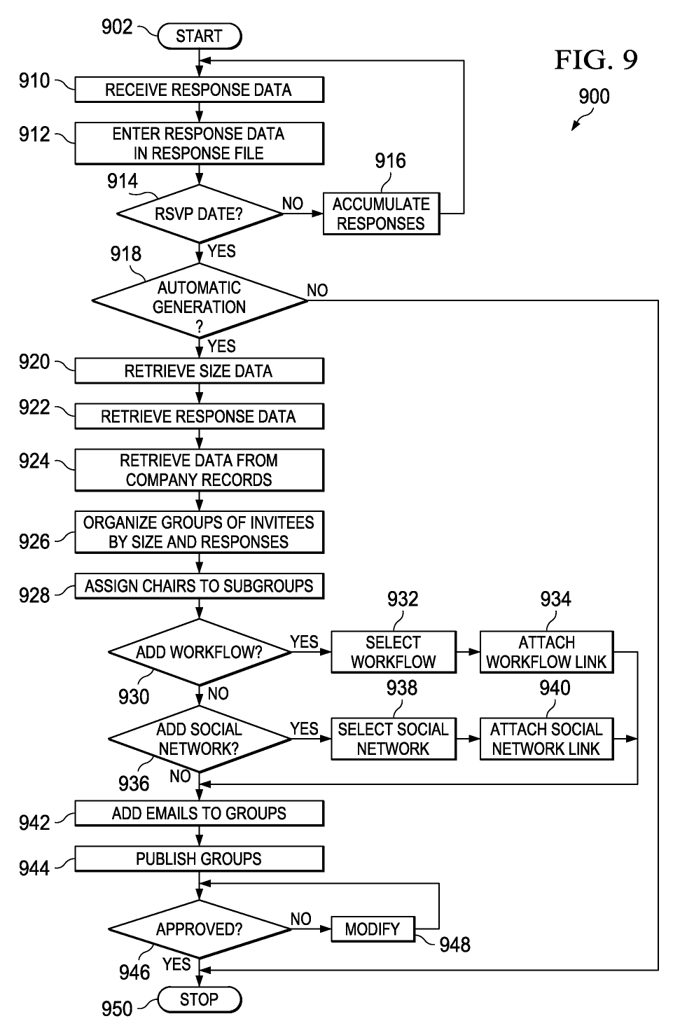

FIG. 5B depicts graphical user interface 500. Graphical user interface 500 has configuration tab 501, survey tab 502, initial invitation tab 503, and group organization tab 504. Selection of configuration tab 501 will present configuration screen 510 (FIG. 5C) to a user and cause configuration component 600 to run (See FIG. 6). Selection of survey tab 502 will present survey screen 520 (see FIG. 5D) to the user and cause survey component 700 to run (see FIG. 7). Selection of initial invitation tab 503 will cause initial invitation component 800 to run (see FIG. 8). Selection of group organization tab 504 will cause group generation component 900 to run (see FIG. 9).

FIG. 5C depicts configuration screen 510. Configure screen 510 has first window 512 identified by “number of subgroups” 511, second window 514 identified by “minimum subgroup size” 513, and third window 516 identified by “maximum subgroup size” 515. To configure Dynamic Meeting Group Organizer 400, the user enters the number of subgroups in first window 512, the minimum subgroup size in second window 514, and the maximum subgroup size in third window 516. The term “subgroup size parameter” shall mean any value used to determine the size of a subgroup.

FIG. 5D depicts survey screen 520 having criteria window 522 identified by criteria 521 and question window 524 identified by question 525. “Associate with” 523 is displayed between criteria window 522 and question window 524 to show that each question selected will be associated with the criteria present in criteria window 522. In addition, a user may activate “another criteria” control 526, “another question” control 527, “enter new criteria” control 528, or “enter new question” control 529. By placing a cursor over criteria window 522, a criteria drop down menu (not shown) will be displayed from which the user may select a criteria. In like manner, by placing the cursor over question window 520, a drop down menu (not shown) will be displayed from which the user may select a question. The user may indicate another criteria by activating “another criteria” control 526. In like manner, the user may indicate another question by activating “another question” control 537. When the user wants to enter a new criteria—i.e, one that is not on the drop down menu—the user activates “enter new criteria” control 528. In like manner, when the user wants to enter a new question, the user activates “enter new question” control 529.

When the user activates enter “new criteria” control 528, new criteria screen 530 will appear. Referring to FIG. 5E, the user may enter the new criteria in new criteria window 532 by activating “enter” control 533. The user may use a drop down menu of existing criteria (not shown), or the user may enter a new criteria.

When the user activates enter new question control 529 on FIG. 5D, new question screen 540 will appear (see FIG. 5F). The user may enter the new question in window 542 identified by “new question” 541 and associate the new question with a criteria in criteria window 544 identified by criteria 545. The user may use a drop down menu of existing criteria, or the user may enter a new criteria. As indicated by “associate with” control 543, the new question entered into new question window 542 will be associated with the criteria entered in criteria window 544.

By way of example, a meeting originator (the user) is responsible for a organizing a large meeting consisting of several hundred potential participants each of whom can either volunteer to participate, or decline. The user determines that there will be twenty groups so the maximum and minimum group size is 20. The user wants each group to research marketing data for a particular geographic area of the United States. Therefore, it would be advantageous to divide the 20 groups according to the attendees' work locations. Therefore, a criteria is established that the attendees share a common location. Thus, using the survey component, the user would create a survey by defining one or more questions that would gather information about the attendee's location. The user would either select questions from the drop down menu or create a new question to associate with the criteria. The user would also select multiple possible answers, and/or create a new answer to associate with a question.

FIG. 6 depicts a flow chart of the logic of configuration component 600. Configuration component 600 starts (602) when the user selects configuration tab 501 on Dynamic Meeting Group Organizer 400's graphical user interface 500. Configuration component 600 displays configuration screen 510 (610). The user enters the number of subgroups (620), enters the minimum subgroup size (630), enters the maximum subgroup size (640), saves the entries (650), and stops (660).

FIG. 7 depicts a flow chart of the logic of survey component 700. Survey component 700 begins (702) when the user activates survey tab on graphical user interface 500 and displays survey screen 520 (704). Using the graphical user interface, a user chooses whether to use the drop-down menu (706). If the user chooses not to use the drop down menu, then the user activates the new criteria screen (708), enters a new criteria (710), and survey component 700 goes to step 714. If the user chooses to use the drop down menu, the user selects a criteria (712). At step 714, the user chooses whether to use the drop down question menu (714). If the user chooses not to use the drop down question menu, then the user activates the new question screen (716), enters a new question (718), and associates the new question with a criteria (720). If the user chooses to use the drop down menu, the user selects a question (722) and the user determines whether to select enter another question (724). If the user wants to enter another question, then survey component 700 goes to step 714, and if not, the user determines whether to enter another criteria (726). If so, survey component 700 goes to step 714, and if not, displays the survey (730). Survey component 700 determines whether the user approves of the displayed survey (728). If not, survey component 700 goes to step 706. If the user approves, survey component stops (740).

FIG. 8 depicts initial invitation component 800. Initial invitation component 800 starts (802) and the user enters a list of invitees (810). The user enters an RSVP date (812) and attaches the survey (814) from survey component 700. The user then sends the initial invitations (816). The user determines whether to use automatic group generation (818). If the user chooses not to use automatic group generation, then initial invitation component 800 notifies the user at the RSVP date so that the user can manually group the invitees. When the user chooses automatic group generation, initial invitation component 800 will set Dynamic Meeting Group Organizer 400 for automatic generation by activating group generation component 900 (822). Initial invitation component stops (830).

In FIG. 9, Group generation component 900 starts (902) and receives response data in response to the initial invitations (910). Group generation component 900 enters the response data in responses file 460 (912). Group generation component 900 determines whether the date is the RSVP date (914). If the date is not the RSVP date, group generation component 900 accumulates responses (916) and goes to step 910. If the date is the RSVP date, group generation component 900 determines whether automatic generation has been activated (918). If not, group generation component 900 stops (950). If group generation has been activated, size data is retrieved from group invitations 480 (920). Response data is retrieved from responses file 460 (922). Records data is retrieved from company records file 440 (924). Groups of invitees are organized by size and responses (926). Chairs are assigned to each group (928). A determination is made whether workflows are to be added (930). If so, workflows are selected from workflow file 430 (932) and a link to the workflow is attached to the group (934). If workflows are not to be added, a determination is made whether a social network is to be added. If so, a social network is selected from the social network website file 420 (938) and a link to the social network website is attached to the group (940). Email addresses are added to the group (942) and the groups are published (944). A determination is made whether the user approves of the grouping (946). If not, the groups are modified (948). Group generation component 900 stops (950).

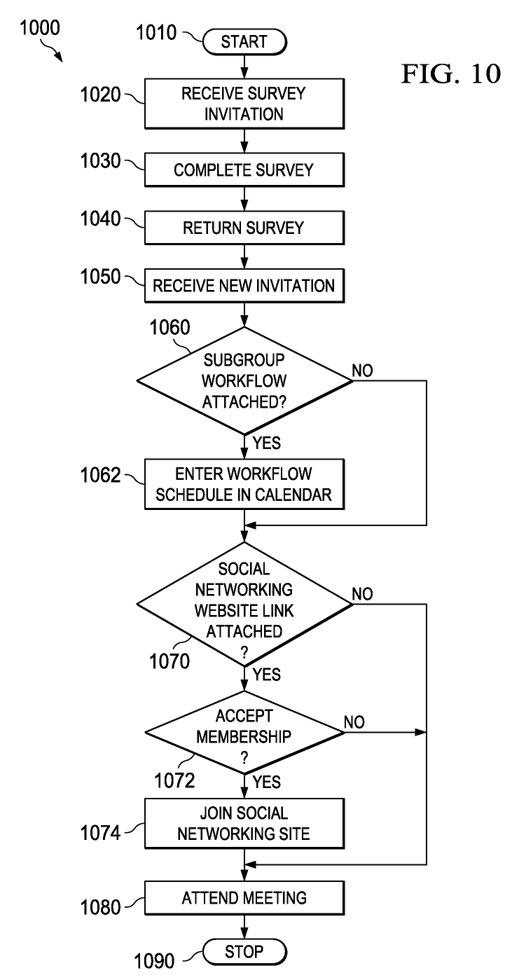

Referring to FIG. 10, invitee component 1000 is depicted. Invitee component 1000 starts (1010) and the invitee receives the survey invitation (1020). The invitee completes the survey invitation (1030) and returns the survey invitation (1040). The invitee receives a new invitation (1050) and determines if a subgroup workflow is attached (1060). If so, the subgroup workflow is entered into the invitees' calendar program (1062). If not, a determination is made whether a social networking website is attached (1070). If a social networking website link is attached, the invitee determines whether to accept membership in the social networking website (1072). If so, the invitee joins (1074) and if not, attends the meeting (1080), and the invitee component stops (1090).

In another embodiment, the user could choose either a “Schedule Meeting Now” control or a “Gather Interest First” control. (not shown) If the user chooses “Schedule Meeting Now” the user would enter a list of invitees. If the user chooses “Gather Interest First” the user would enter the list of invitees, select an RSVP date, and determine whether to include only positive responses, or to include positive responses and tentative responses. The user would attach a previously defined survey or select “Define a Survey Now.”

In another embodiment, the user determines whether to divide the meeting into sub-meetings. If the user chooses to divide the meetings into sub-meetings, the user specifies the number of sub-meetings, divide the meeting by schedule, location, time zone, division, random, and so forth. The user applies the survey results and enters the minimum and maximum group size.

For example, a user who wishes to start a networking group, might have a survey question as follows: What would you like to network about most? With the following responses: “work-life balance.” “getting ahead in business” and “getting ahead in technology.” Once the responses are gathered, the user could choose to divide this meeting into sub-meetings based on the survey results on a particular question or combination of questions, and the program would automatically correlate like-minded individuals.

The calendar program then analyzes schedules and presents the chairperson with recommended grouping, in separate boxes (lists). The meeting initiator can make adjustments such as reassigning the chairperson. When the current meeting is being subdivided, this option appears for each sub-meeting. The option of reassigning the meeting chairperson supports this new meeting type but is not limited to it.

The calendar software program would form the groups, using, in this case, input from the employee directory or employee data base. If the option selected had been “random,” no additional information would be used in assigning invitees to groups.

If the number of acceptances was insufficient to form the desired number of groups with the minimum number of members, the minimum member requirement would override the total groups requirement. Similarly, if the maximum member requirement was exceeded, it would take precedence and more groups would be formed. Once members of each group were selected, a chairperson would be selected using the criteria specified.

The list of groups and members would be sent to the meeting originator, who could either confirm acceptance of the current allocations, or modify the criteria and rerun the group selection process. This process would continue until the meeting originator confirmed acceptance of the groupings.

Once the groups were finalized, the meeting originator would receive a distribution list for each group and could send further instructions, customized material, etc. to each group distribution list along with the name of its individual chairperson. Further communication with an individual group could easily be limited to the distribution list for that group.

Another embodiment of the invention would involve the use of workflow scripts, social networking, dynamic surveys and follow-up dates. For example, applying the Dynamic Work Groups Organizer to a hypothetical municipal government plan for a study to determine whether Web based assistance from peer senior citizens can benefit older Americans in their daily lives. In order to implement the Dynamic Work Groups Organizer in this example, automated follow-up dates, dynamic surveys, and workflow scripts are added. The Dynamic Work Group Organizer schedules an optional workflow script, launches the workflow script for each group, and associates follow-up dates with each group. The Dynamic Work Group Organizer allows follow-up dates involving additional meeting invitations, emails, and surveys to be predefined and automatically sent on the target dates. Alternatively, the chairperson can be reminded to create the additional material.

In this example, all voters over the age of 70 in the municipality are invited to join the study, but participation is voluntary and limited to voters with email addresses and Internet access. When voters do not have email addresses on file, invitations are sent by United States Postal Service mail and the recipients asked to respond by email. As in the original embodiment, the chairperson would send invitations, gather interest, and using an RSVP date, select only positive responses. In this example, the list of invitees who had accepted the invitation would become the general participation group, which would be divided into subgroups, with a maximum of 20 senior citizens in each group, based on responses to dynamically defined survey (see supra for description of dynamically defined surveys). The survey would include a list of primary topics of interest and other demographical data for forming the groups.

The ultimate goal would be to facilitate communication using a social networking Web site with each group having its own distinct private relationships. The invitations to the social networking Web Site would be generated by a workflow associated with the study and customized for each of the groups. Once having accepted, participants would use the Web site to interact in the customary way. Group members could discuss topics of interest, ask for help with problems, exchange recipes, etc. It is assumed that the privacy policy for the social Web site would be acceptable to all participants and that the owners of the site would monitor communications for defamatory or other unacceptable posting.

Using the follow-up dates, the study participants would be sent an invitation to a follow-up conference call. The study leaders would use that opportunity to interview the participants and rate the success of the experiment.

The flowchart and block diagrams in the Figures illustrate the architecture, functionality, and operation of possible implementations of systems, methods and computer program products according to various embodiments of the Delta Framework Software. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the Dynamic Meeting Group Organizer has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can store the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the Dynamic Meeting Group Organizer has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A computer implemented process to automatically create sub-groups from a group of responders to a meeting invitation sent by email, comprising:
using a computer and a graphical user interface displayed by the computer, and responsive to a plurality of subgroup inputs to a first screen of the graphical user interface, determining a number of subgroups and a subgroup size parameter;
responsive to a plurality of survey inputs to a second screen of the graphical user interface, determining a question and a criteria associated with the question to create a survey;
responsive to a plurality of list inputs, determining a list of invitees and a response date by which an invitee is to return a plurality of responses in a completed survey;
sending a plurality of invitations with the survey attached to each invitee on the list;
accumulating the plurality of responses in a response file; and
accessing the response file and automatically processing the plurality of responses by organizing the list of invitees into a plurality of subgroups according to each invitee's response to the question, the subgroup size, and the subgroup size parameter.

2. The computer implemented process of claim 1, further comprising:
assigning a chairperson to each subgroup.

3. The computer implemented process of claim 2, further comprising:
publishing the plurality of groups by email wherein each subgroup group has a different email address.

4. The computer implemented process of claim 3 further comprising:
updating a plurality of calendars with a plurality of dates for each of the plurality of groups.

5. The computer implemented process of claim 4, further comprising:
sending a new invitation configured for each subgroup.

6. The computer implemented process of claim 5 further comprising:
selecting a workflow from a workflow file and linking the workflow to a subgroup.

7. The computer implemented process of claim 6 further comprising:
selecting a social network website from a social network website file and linking the social network website to a subgroup.

8. An apparatus to automatically create sub-groups from a group of responders to a meeting invitation sent by email, comprising:
a computer connected to a memory;
a program in the memory adapted to cause the computer to display a graphical user interface and to perform steps comprising:
responsive to a plurality of subgroup inputs to a first screen of the graphical user interface, determining a number of subgroups and a subgroup size parameter;
responsive to a plurality of survey inputs to a second screen of the graphical user interface, determining a question and a criteria associated with the question to create a survey;
responsive to a plurality of list inputs, determining a list of invitees and a response date by which an invitee is to return a plurality of responses in a completed survey;
sending a plurality of invitations with the survey attached to each invitee on the list;
accumulating the plurality of responses in a response file; and
accessing the response file and automatically processing the plurality of responses by organizing the list of invitees into a plurality of subgroups according to each invitee's response to the question, the subgroup size, and the subgroup size parameter.

9. The apparatus of claim 8, wherein the program is adapted to cause the computer to perform steps further comprising:
assigning a chairperson to each subgroup.

10. The apparatus of claim 9, wherein the program is adapted to cause the computer to perform steps further comprising:
publishing the plurality of groups by email wherein each subgroup group has a different email address.

11. The apparatus of claim 10, wherein the program is adapted to cause the computer to perform steps further comprising:
updating a plurality of calendars with a plurality of dates for each of the plurality of groups.

12. The apparatus of claim 11, wherein the program is adapted to cause the computer to perform steps further comprising:
sending a new invitation configured for each subgroup.

13. The apparatus of claim 12, wherein the program is adapted to cause the computer to perform steps further comprising:
selecting a workflow from a workflow file and linking the workflow to a subgroup.

14. The apparatus of claim 13, wherein the program is adapted to cause the computer to perform steps further comprising:
selecting a social network website from a social network website file and linking the social network website to a subgroup.

15. A computer program product to automatically create sub-groups from a group of responders to a meeting invitation sent by email, comprising:
computer program code stored in a computer-readable medium, the computer program code adapted to cause a computer to display a graphical user interface and to perform steps comprising:
responsive to a plurality of subgroup inputs to a first screen of the graphical user interface, determining a number of subgroups and a subgroup size parameter;
responsive to a plurality of survey inputs to a second screen of the graphical user interface, determining a question and a criteria associated with the question to create a survey;
responsive to a plurality of list inputs, determining a list of invitees and a response date by which an invitee is to return a plurality of responses in a completed survey;
sending a plurality of invitations with the survey attached to each invitee on the list;
accumulating the plurality of responses in a response file; and
accessing the response file and automatically processing the plurality of responses by organizing the list of invitees into a plurality of subgroups according to each invitee's response to the question, the subgroup size, and the subgroup size parameter.

16. The computer program product of claim 15, wherein the computer program code is adapted to cause the computer to perform steps further comprising:
assigning a chairperson to each subgroup.

17. The computer program product of claim 16, wherein the computer program code is adapted to cause the computer to perform steps further comprising:
publishing the plurality of groups by email wherein each subgroup group has a different email address.

18. The computer program product of claim 17, wherein the computer program coded program is adapted to cause the computer to perform steps further comprising:
updating a plurality of calendars with an plurality of dates for each of the plurality of groups.

19. The computer program product of claim 18, wherein the computer program code is adapted to cause the computer to perform steps further comprising:
sending a new invitation configured for each subgroup.

20. The computer program product of claim 19, wherein the program is adapted to cause the computer to perform steps further comprising:
selecting a workflow from a workflow file and linking the workflow to a subgroup; and
selecting a social network website from a social network website file and linking the social network website to a subgroup.
